(19) United States
(12) Patent Application Publication
(10) Pub. No.: US 2016/0042374 A1
(43) Pub. Date: Feb. 11, 2016

(54) Methods and Systems for Identifying Merchant and ATM Demand

(71) Applicant: MASTERCARD INTERNATIONAL INCORPORATED, Purchase, NY (US)

(72) Inventors: David Weis, Borne, TX (US); Roopa Vaidya, Elmsford, NY (US); Michael Cardamone, New Windsor, NY (US)

(21) Appl. No.: 14/456,593

(22) Filed: Aug. 11, 2014

(51) Int. Cl. G06Q 30/02

(52) U.S. Cl. CPC G06Q 30/0205

(57) ABSTRACT

Methods and systems are provided for identifying demand at, for example, merchants and ATMs located within selected geographic boundaries, and over a selected time frame. Transaction data for transactions conducted over the selected time frame is received at a computing device, and location data is associated with each of the transactions. The location data generally corresponds to a location at which each of the transactions occurred. The transactions are then grouped into geographic boundaries based on the location data. For each of the geographic boundaries, the transaction data is compared to a predefined benchmark. And, for each of the geographic boundaries satisfying the benchmark, demand indices are generated indicative of financial demand in the geographic boundary.

### FIELD

The present disclosure generally relates to methods and systems for identifying demand at, for example, merchants, ATMs, etc. located within selected geographic boundaries, and over a selected time frame.

### BACKGROUND

This section provides background information related to the present disclosure which is not necessarily prior art.

Payment cards are used in numerous different transactions at numerous different places including, for example, at merchants, at automated teller machines (ATMs), etc. Because the transactions are often routed through payment service entities for approval, data related to the transactions is accessible to the payment service entities.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying financial demand at merchants and ATMs;

FIG. 2 is a block diagram of a computing device, that may be used in the exemplary system of FIG. 1;

FIG. 3 is an exemplary method for identifying financial demand at merchants and ATMs within selected geographic boundaries during a selected time frame; and

FIGS. 4-10 illustrate portions of an exemplary interface suitable for use in the system of FIG. 1 and/or the method of FIG. 3 to interact with a map showing financial demand at merchants and ATMs.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Transaction data for a purchasing entity (e.g., a consumer, etc.) can be useful in identifying purchase details and other financial actions for the purchasing entity. Similarly, transaction data for multiple purchasing entities can be useful in identifying not only purchase details and other financial actions for the multiple purchasing entities, but also various financial trends for locations where the transactions occurred. With that said, in the described embodiments herein, methods and systems identify financial demand within selected geographic boundaries for merchants and automated teller machines (ATMs) therein, over selected time frames, based on the transaction data for the multiple purchasing entities at the merchants and ATMs. In some aspects, this financial demand can then be presented to users graphically, as desired.

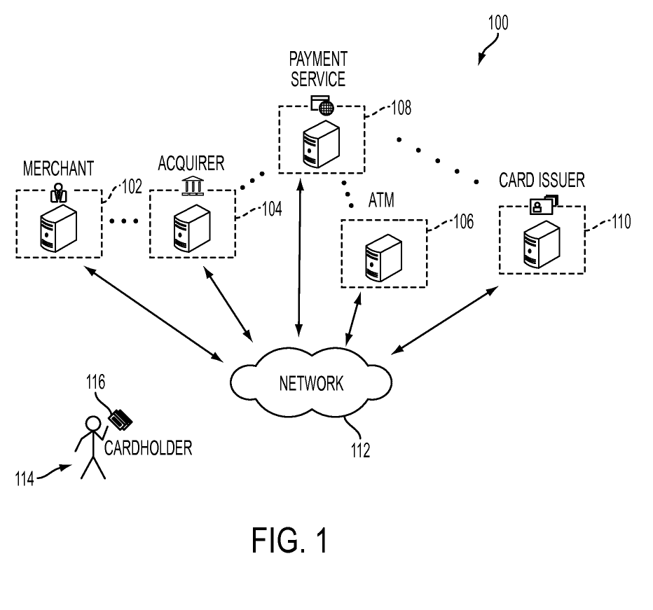

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on authorization processes for payment card transaction systems, etc.

The illustrated system 100 generally includes a merchant 102, an acquirer 104, an ATM 106 (e.g., an owner of the ATM, etc.), a payment service 108, and an issuer (and/or issuer bank) 110, each coupled to network 112. The network 112 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 112 includes multiple networks, where different ones of the multiple networks are accessible to different ones of the illustrated components in FIG. 1 (e.g., a private card transaction network made accessible by the payment service 108 and the Internet, etc.). And, while the merchant 102 and the ATM 106 are illustrated as a single merchant and a single ATM in FIG. 1, it should be appreciated that in the system 100 the merchant 102 may represent multiple merchants and/or the ATM 106 may represent multiple ATMs.

In one aspect, the merchant 102, the acquirer 104, the payment service 108, and the issuer 110 cooperate, in response to a purchasing entity 114 (e.g., a purchase by the purchasing entity 114), to complete a financial transaction at the merchant 102. The purchasing entity 114 initiates the transaction by presenting a payment card 116 (e.g., a credit card, a debit card, a pre-paid card, an ATM card, etc.), issued by the issuer 110, to the merchant 102. The merchant 102 reads the payment card 116 (and, in some cases, requests a personal identification number (PIN) to authorize the payment card 116) and communicates the account number and an amount of the purchase to the acquirer 104 to determine whether the card is in good standing and whether there is sufficient credit to complete the transaction. The acquirer 104, in turn, communicates with the issuer 110, through a payment service 108, such as, for example, a credit card payment system using the MasterCard® interchange, for authorization to complete the transaction. If the issuer 110 accepts the transaction, an authorization is provided back to the merchant 102 and the merchant 102 completes the transaction.

In another aspect, the ATM 106, the payment service 108, and the issuer 110 cooperate, in response to the purchasing entity 114, to complete a financial transaction at the ATM 106. Here, the purchasing entity 114 initiates the transaction by presenting the payment card 116 to the ATM 106. The ATM 106 reads the payment card 116 and requests a PIN for confirmation. The ATM 106 then communicates the account number and a transaction amount (e.g., a requested withdrawal amount, etc.) to the issuer 110, through the payment service 108 (e.g., again via the credit card payment system using the MasterCard® interchange, etc.) for authorization to complete the transaction. If the issuer 110 accepts the transaction, an authorization is provided back to the ATM 106 and the ATM 106 completes the transaction (e.g., dispenses the requested cash, etc.).

Regardless of the type of transaction, transaction data is generated as part of the interactions among the merchant 102, the acquirer 104, the ATM 106, the payment service 108, the issuer 110, and the purchasing entity 114. The transaction data includes a plurality of payment card events. And, for each event, the transaction data may include, without limitation, an account number of the payment card 116, an amount of the transaction, a location of the transaction, a date/time of the transaction, combinations thereof, etc. This transaction data is transmitted from the merchant 102 or ATM 106, depending on the transaction, to the issuer 110 through the payment service 108. In so doing, the transaction data may be stored in different components of the system 100. In various embodiments, the payment service 108, for example, collects and stores the transaction data. As such, the payment service 108 can use the transaction data to identify demand for the merchant 102 and the ATM 106 over a selected time frame, along with any other merchants and ATMs for which transaction data has been collected and stored. With that said, it should be appreciated that the same or different transaction data may be collected and stored within other components of the system 100.

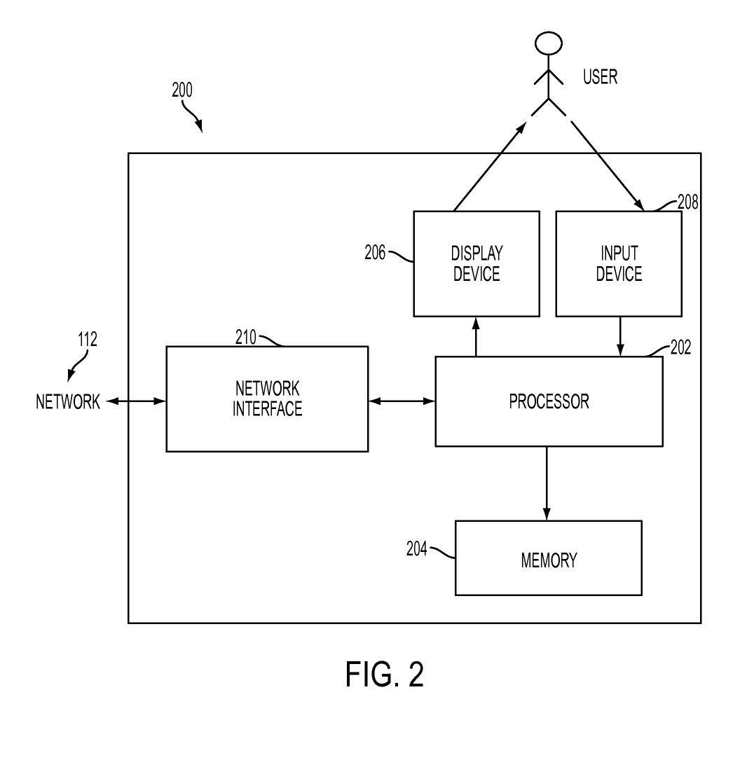

FIG. 2 illustrates an exemplary computing device 200. In the exemplary embodiment of FIG. 1, each of the merchant 102, the acquirer 104, the ATM 106, the payment service 108, and the issuer 110 are illustrated as including computing device 200. The computing device 200 may include, for example, one or more servers, personal computers, laptops, tablets, PDAs, smartphones, etc. as appropriate. The system 100, and its components, however, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 112 (e.g., capable of supporting communication between the computing device 200 and the network 112, etc.), or separate therefrom.

The exemplary computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, flash drives, hard disks, and/or any other type of volatile or nonvolatile physical or tangible computer-readable media. The memory 204 may be configured to store, without limitation, account information, transaction data, demand indices, user requests for identifying financial demand, and/or other types of data suitable for use as described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes a display device 206 that is coupled to the processor 202. The display device 206 outputs to a user (e.g., the purchasing entity 114; individuals associated with one or more of the merchant 102, the acquirer 104, the ATM 106, the payment service 108, and the card issuer 110; individuals requesting financial demand information; etc.) by, for example, displaying and/or otherwise outputting information such as, but not limited to, account data, transaction data, demand indices, graphical representations thereof, and/or any other type of data. It should be further appreciated that various interfaces (e.g., graphic user interfaces (GUI), or webpages, etc.) may be displayed at computing device 200, and in particular at display device 206, to display demand indices for various merchants and/or ATMs as well as other transaction data, etc. And in some cases, the computing device 200 may cause the interfaces to be displayed at the display device 206 of another computing device, including, for example, a server hosting a website having multiple interfaces (e.g., webpages, etc.), etc. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both display device 206 and input device 208.

In addition, the illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

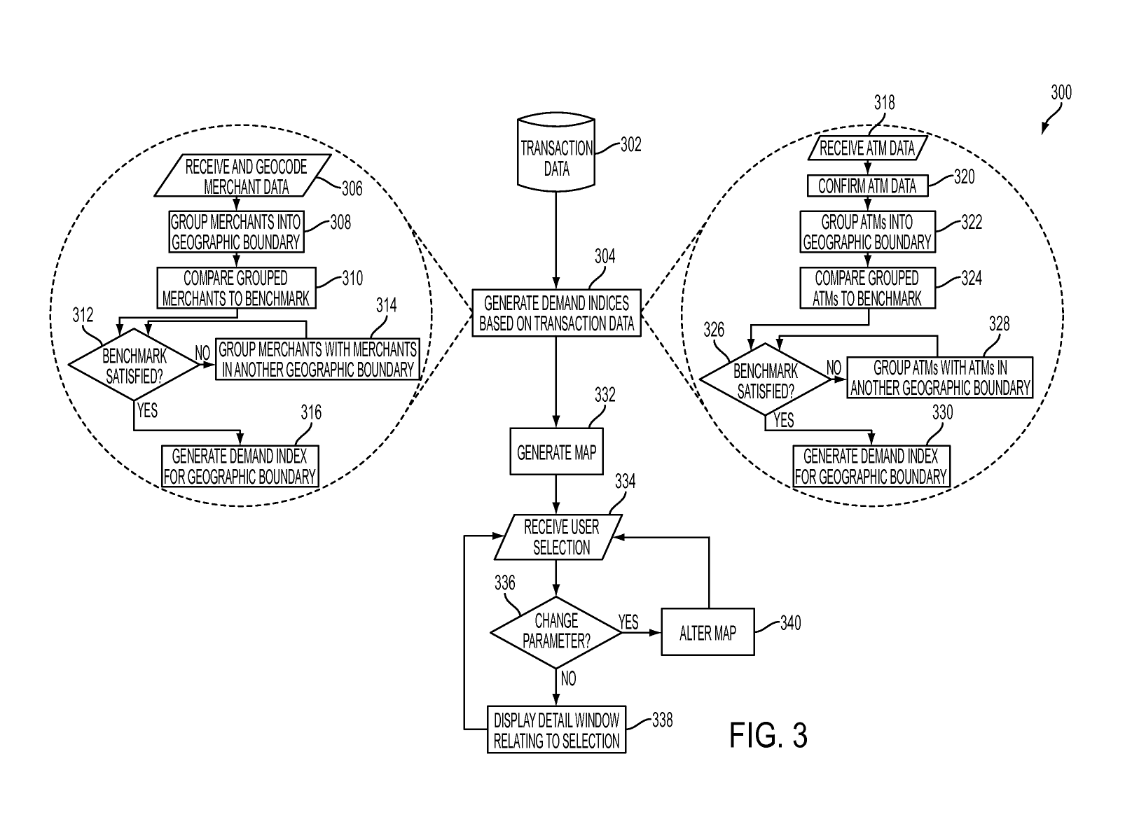

FIG. 3 illustrates an exemplary method, at 300, for identifying financial demand for merchants (e.g., merchant 102, etc.) and ATMs (e.g., ATM 106, etc.) within desired geographic boundaries over desired time frames. The exemplary method 300 is described as implemented in the payment service 108 of the system 100. However, it may be implemented in any one or more of the merchant 102, the acquirer 104, the ATM 106, or the issuer 110 of the system 100, or in any other entity. In addition, for purposes of illustration, the exemplary method 300 is described herein with reference to the computing device 200. However, it should be appreciated that the methods described herein are not limited to the system 100, or computing device 200. And, conversely, the systems and computing devices described herein are not limited to the exemplary method 300.

As shown in FIG. 3, transaction data is initially collected and stored by the payment service 108, at 302, in memory 204 of the payment service computing device 200. The transaction data can include any transaction data. In the illustrated method 300, for example, the transaction data includes both merchant transaction data (merchant data) and ATM transaction data (ATM data). In addition, in collecting and storing the transaction data, the transaction data is also organized, in the memory 204, by one or more of transaction location (e.g., address, city, state, region, etc. of where the transaction occurred), transaction type (e.g., debit, credit, ATM, prepaid, etc.), merchant category code (MCC) (e.g., fuel, restaurant, pharmacy, etc.), etc.

Desired transaction data is next selected from the memory 204 and used, by the payment service 108, to generate demand indices at 304. In the illustrated embodiment, the selected transaction data includes merchant data and ATM data for multiple merchants (e.g., merchant 102, etc.) and ATMs (e.g., ATM 106, etc.) in a selected geographic location over a selected time frame (e.g., such that the demand indices may include merchant demand indices and ATM demand indices, etc.). The selected geographic location can include any desired location such as a country, a state, a county, a direct marketing area, a city, a postal code, a block group, a census tract, an address, any standard or user defined shape and/or boundary, combinations thereof, etc. And, the selected time frame can include any desired time frame such as a hour, a day, a week, a month, a quarter, a year, etc. In addition, in some embodiments, the selected transaction data may even include real time, near real time, or batch processing transaction data for a selected geographic location. Further, in some embodiments, the transaction data may be selected based on transaction type, merchant category, North American industry classification system (NAICS) code, standard industrial classification (SIC) code, MCC, etc.

As can be appreciated, the demand indices may be used to represent demand for (or consumer use of) particular merchants and ATMs at the selected geographic location over the selected time frame. As such, the indices can provide an indication to a user (e.g., an owner of the merchants and/or ATMs, a competitor of the merchants and/or ATM owners, etc.) of how well the merchants and the ATMs, in the selected geographic area or location, performed during the selected time frame. In addition, in some aspects the indices can also be used to identify optimum locations for site expansions, etc.

In the illustrated method 300, the demand indices include separate indices for the merchant data and the ATM data (although the indices could be combined if desired). The indices for the merchant data and the indices for the ATM data may be generated at about the same time, or at different times as desired. In addition in the illustrated method 300, the indices for each of the merchant data and the ATM data further include separate indices for transaction count (e.g., the number of transactions that occurred at merchants and ATMs in the selected geographic location, etc.) and transaction amount (or volume) (e.g., the monetary value of the transactions that occurred at the merchants and the ATMs in the selected geographic location, etc.). The indices for the transaction count and the indices for the transaction amount may also be generated at about the same time, or at different times as desired. In other embodiments, indices for only the merchant data may be generated, or indices for only the ATM data may be generated. In addition, in some embodiments the indices for the merchant data and/or the indices for the ATM data may include indices for only transaction count or indices for only transaction amount. And, in still other embodiments, the indices for the merchant data and the ATM data may also (or alternatively) include indices for other characteristics of the transactions such as, for example, MCC, card type, characteristics indicative of fraudulent transactions at the merchants or the ATMs, etc.

With continued reference to FIG. 3, in generating the demand indices for the merchant data, the merchant data is received, by the payment service 108, from the memory 204 and geocoded at 306 by the processor 202 of the payment service computing device 200. The received merchant data is for the selected geographic location to be analyzed, during the selected time frame. Geocoding the merchant data includes associating specific location data, for example, latitude and longitude coordinates, etc. with the merchant data (e.g., with the merchants, with the corresponding transactions, etc.) based on addresses of the merchants where the corresponding transactions occurred. In so doing, the merchants (along with the corresponding transaction data for the merchants) are preliminarily plotted on a map, and additional specific geographic information for the merchants is then obtained from the map (e.g., information in addition to that included in the merchant data, etc.), including block group, census tract, etc. In some aspects, the additional specific geographic information may also (or alternatively) be obtained (and stored in the memory 204 of the computing device 200) during the initial geocoding process itself. In some embodiments, after geocoding the merchant data, history tables of the obtained geographic information for the merchants are created so that, in future analyses, the geocoding operation does not need to be repeated for the same merchants (unless or until the corresponding geographic boundaries are recreated or regenerated, for example, by the government (e.g., every ten years, etc.), etc.). With that said, it should be appreciated that any suitable mapping tools may be used to geocode and map the merchant data including, for example, MapMarker® from Pitney Bowes Inc., MapInfo® professional from Pitney Bowes Inc., etc.

After geocoding (and mapping) the merchant data, the corresponding merchants (and the associated transactions) are grouped together, by the processor 202, into desired geographic boundaries at 308. The geographic boundaries are located within the selected geographic location. The grouping can be based on any desired geographic information for the merchants contained in the merchant data or obtained when the merchant data is geocoded (e.g., country, state, county, direct marketing area, city, postal code, block group, census tract, address, user defined boundaries, combinations thereof, etc.). As can be appreciated, the geographic boundaries are then defined by the specific geographic information used to group the merchants (e.g., zip code, bock group, census tract, etc.).

Once the merchants are grouped, the merchant data for the merchants in each of the geographic boundaries is compared by the processor 202 to a predefined benchmark at 310. In the illustrated method 300, this includes calculating, for each geographic boundary, the total number of merchants in the geographic boundary and each merchant's percentage of the total transaction amount (and volume or transaction count), for the selected time frame, in the geographic boundary. The benchmark is satisfied, at 312, if the geographic boundary includes a predefined total number of merchants/locations (e.g., at least five merchants, etc.), and no one of the merchants in the geographic boundary comprises more than a predefined percentage (e.g., about twenty-five percent or more, etc.) of the total transaction amount (and/or count) in the geographic boundary. If, however, the benchmark is not satisfied at 312, the merchants in the geographic boundary are combined with merchants in another geographic boundary at 314 (e.g., an adjacent geographic boundary, etc.) in order for the merchants to satisfy the benchmark. It should be appreciated that, in other embodiments, other benchmarks may be used as a basis of comparison in analyzing the grouped merchants in the geographic boundaries. In addition, in still other embodiments, merchants in geographic boundaries that do not satisfy the benchmark may not be combined with merchants in other boundaries. Instead, the merchants may be omitted from the analysis until such time as their geographic boundaries satisfy the benchmark. Or the geographic boundaries for the merchants may be re-determined based on other geographic information (e.g., so that the benchmark is satisfied, so that the merchants are not omitted, etc.).

The demand indices for transaction count and transaction amount, for the merchant data, are then generated, by the processor 202, at 316 for each geographic boundary that satisfies the predefined benchmark. The demand indices generally convert values for the actual transaction count and the actual transaction amount in the geographic boundaries to a scale of one to one hundred. Any indices generated with a value of greater than one hundred are reset to one hundred. As can be appreciated, converting the actual transaction count and transaction amount values for the geographic boundaries to a relative scale can provide convenience for comparison as well as security to the merchants (as actual values are then not shown).

With further reference to FIG. 3, in generating the demand indices for the ATM data, the ATM data is received, by the payment service 108, from the memory 204 at 318, and locations of the ATMs from which the data originated are confirmed at 320 by the processor 202. This confirmation helps ensure that the received ATM data is associated with the correct ATM, and thus assigned a correct geographic location. As an example, the ATM data received from the memory at 204 (e.g., debit switch data, etc.) may use different names, abbreviations, etc. for identifying the location of the ATM from which it originated, and thus may appear to originate from multiple different ATMs located in the same general vicinity. To ensure that the ATM data is associated with the correct one of the ATMs, the received ATM data is compared to predetermined data for each of the ATMs in the vicinity (e.g., previously collected, supplied, etc. data for the ATMs from owners of the ATMs, processing systems of the ATMs, sponsors of the ATMs, etc.). This can include comparing particular portions of the received ATM data with corresponding portions of the predetermined data (e.g., routing ID, terminal ID, state, city, address, combinations thereof, etc.) to match, link, etc. the ATM data with the actual one of the ATMs used to generate the ATM data. It should be appreciated that this confirmation operation may also apply (and/or be applied) to merchant locations, as merchant names in the transaction data may need to be mapped to other sets of merchant data such, for example, Dun & Bradstreet merchants, etc.

Then, as described for the merchant data, the ATM data is geocoded by the processor 202. The received ATM data is for the selected geographic location to be analyzed, during the selected time frame. Geocoding the ATM data includes associating specific location data, for example, latitude and longitude coordinates, with the ATM data (e.g., with the ATMs, with the corresponding transactions, etc.) based on the confirmed addresses of the ATMs where the corresponding transactions occurred. In so doing, the ATMs (along with their corresponding transaction data) are preliminarily plotted on a map, and additional geographic information for the ATMs is then obtained from the map (e.g., information in addition to that included in the ATM data, etc.) including block group, census tract, etc. In some aspects, the additional specific geographic information may also (or alternatively) be obtained (and stored in the memory 204 of the computing device 200) during the initial geocoding process itself. In some embodiments, after geocoding the ATM data, history tables of the obtained geographic information for the ATMs are created so that, in future analyses, the geocoding operation does not need to be repeated for the same ATMs (unless or until the corresponding geographic boundaries are recreated or regenerated, for example, by the government (e.g., every ten years, etc.), etc.). Again, any suitable mapping tools may be used to geocode and map the ATM data including, for example, MapMarker® from Pitney Bowes Inc., MapInfo® Professional from Pitney Bowes Inc., etc.

After geocoding (and mapping) the ATM data, the corresponding ATMs (and associated transactions) are grouped together, by the processor 202, into desired geographic boundaries at 322. The geographic boundaries are located within the selected geographic location. The grouping can be based on any desired geographic information for the ATMs contained in the ATM data or obtained when the ATM data is geocoded (e.g., country, state, county, direct marketing area, city, postal code, block group, census tract, address, user defined boundaries, combinations thereof, etc.). As can be appreciated, the geographic boundaries are then defined by the specific geographic information used to group the ATMs (e.g., zip code, block group, census tract, etc.).

Once the ATMs are grouped, the ATM data for the ATMs in each of the geographic boundaries is compared by the processor 202 to a predefined benchmark at 324. In the illustrated method 300, this includes calculating, for each geographic boundary, the total number of ATMs in the geographic boundary and each ATM's percentage of the total transaction amount (and volume or transaction count), for the selected time frame, in the geographic boundary. The benchmark is satisfied, at 326, if the geographic boundary includes a predefined total number of ATMs/locations (e.g., at least five ATMs, etc.), and no one of the ATMs in the geographic boundary comprises more than a predetermined percentage (e.g., about seventy-five percent or more, etc.) of the total transaction amount (and/or count) in the geographic boundary. If, however, the benchmark is not satisfied at 326, the ATMs in the geographic boundary are combined with ATMs in another geographic boundary at 328 (e.g., an adjacent geographic boundary, etc.) in order for the ATMs to satisfy the benchmark. It should be appreciated that, in other embodiments, other benchmarks may be used as a basis of comparison in analyzing the grouped ATMs in the geographic boundaries. In addition, in still other embodiments, ATMs in geographic boundaries that do not satisfy the benchmark may not be combined with ATMs in other boundaries. Instead, the ATMs may be omitted from the analysis until such time as their geographic boundary satisfies the benchmark. Or the geographic boundaries for the ATMs may be re-determined based on other geographic information (e.g., so that the benchmark is satisfied, so that the ATMs are not omitted, etc.).

The demand indices for transaction count and transaction amount are then generated, by the processor 202, at 330 in each geographic boundary that satisfies the predefined benchmark. The demand indices generally convert values for the actual transaction count and the actual transaction amount in the geographic boundaries to a scale of one to one hundred. Any indices generated with a value of greater than one hundred are reset to one hundred. As can be appreciated, converting the actual transaction count and transaction amount values for the geographic boundaries to a relative scale can provide convenience for comparison as well as security to the owners of the ATMs.

As further illustrated in FIG. 3, once the demand indices are generated for the merchant data and the ATM data, they are incorporated by the processor 202 into a map (along with the corresponding transaction data) for display, in graphical form (e.g., as a heat map, etc.), to the user at 332. The merchant data and the ATM data may be both incorporated into the same map, or they may be incorporated into separate maps. When incorporated into the same map, options may be provided to view both types of data at once, or only one type of data. In other embodiments, the indices may instead be provided in tabular form to compare different geographic boundaries (e.g., adjacent geographic boundaries, etc.). And in some aspects, all geographic boundaries having the same or similar indices (e.g., the same or similar transaction count indices, transaction amount indices, etc.) may be further identified and grouped together for comparison.

In the illustrated method 300, the map can include multiple different layers of data for display to the user at once or at different times. Such layers may include, without limitation, layers showing different transaction data (or different combinations of data) for the merchants (e.g., different point of sale (POS) categories, etc.) and/or the ATMs, layers showing different time frames of the transactions (e.g., hourly, weekly, monthly, quarterly, annually, etc.), layers showing indices for different scales (or levels) of the geographic boundaries, layers showing different demand indices, layers showing transactions made with different card types (e.g., credit card transactions, debit card transactions, prepaid card transactions, etc.), layers showing transactions made with different portfolios within particular card types, etc. In some cases, one or more of the layers of data may only be available to users with permission to view the data such as, for example, the issuer 110, etc. As an example, the demand indices may be generated at several different geographic levels (e.g., country level, state level, county level, direct marketing area level, city level, postal code level, block group level, census tract level, etc.). Each level can be viewed in one or more of the layers of the map (e.g., by altering the map (e.g., by zooming in or zooming out of the map, etc.) to show the different levels of demand at the different geographic levels (e.g., to show the demand indices calculated at the different geographic levels, etc.), etc.).

Also in the illustrated method 300, the map is interactive. As such, a selection relating to one or more parameters of the map can be received at 334 (e.g., from a user, etc.). Upon receiving the selection, the processor 202 determines, at 336, the content of the selection. If the selection includes a request to display detailed data for a particular merchant or ATM or geographic boundary shown on the map, the processor 202 displays a detail window at 338 including the requested information. Alternatively, if the selection includes a request to change a view of the map, the processor 202 alters the map as necessary at 340. Such requests to change the view of the map may include, without limitation, requests to view a different geographic portion of the map (e.g., a portion of the map showing different geographic boundaries, etc.), requests to view a different level of demand on the map for the current geographic portion being viewed, or requests to view a different transaction type (e.g., ATM transactions instead of merchant transactions, etc.). Additional selections that can be received and accommodated by the processor 202 may include, without limitation, requests to track transaction activity over multiple time dimensions, requests to view specific categories of indexes (e.g., for restaurants, etc.), requests to view transactions by card type, etc.

In some aspects, the map may also display indicators of where the purchasing entities are from (e.g., the residential zip codes, etc.) that performed the transactions in the various geographic boundaries. Here, for example, the processor 202 may initially receive and accommodate requests to view particular merchants or ATMs, or particular geographic boundaries. And then, in response to the request, the processor 202 may display a listing of where all transaction data originated for the particular request (e.g., where the purchasing entities are from that performed the transactions, etc.). As can be appreciated, this information may be used to determine what purchasing entities are driving the business at the particular merchants or ATMs within the geographic boundary.

It should be appreciated that the maps described herein can be updated as desired (e.g., every week, every month, every quarter, etc.). For example, any geographic boundaries, for either the merchant data or the ATM data, that did not satisfy the corresponding benchmark in a previously analysis can be reprocessed and updated in a subsequent analysis. In addition, the indices calculated in the subsequent analysis may also then be used, retroactively, to update the map for the prior analysis.

### EXAMPLES

The following examples are exemplary in nature. Variations of the following examples are possible without departing from the scope of the disclosure.

### Example 1

In the following example, demand indices are generated for select merchant data, spanning a one-month time frame, for fifteen merchants in the geographic location of Town. In so doing, the merchant data was initially geocoded to associate various geographic information therewith. Tables 1 and 2 show the geocoded merchant data for the fifteen merchants. The geographic information provided for the geocoded data includes, for each merchant, the merchant address (street, city, and postal code), the latitude (Lat.) and longitude (Lon.) coordinates of the merchant, the block group comprising the merchant, and the census tract comprising the merchant. In addition, Table 1 also provides the transaction count data (Count) and the transaction amount data (Amount) for each merchant during the one-month time frame.

TABLE 1

| | | | Postal | | | | |
|---|---|---|---|---|---|---|---|
| Merchant | Street | City | Code | Count | Amount | Lon. | Lat. |
| AAA Inc. | 1 Street | Town | 11111 | 247 | $90,238 | 90.2978 | 38.1272 |
| BBB Inc. | 2 Street | Town | 33333 | 108 | $199,920 | 90.1078 | 38.6272 |
| CCC Inc. | 3 Street | Town | 12345 | 726 | $150,280 | 90.1968 | 38.6212 |
| DDD Inc. | 4 Street | Town | 11111 | 810 | $110,500 | 90.4978 | 38.3272 |
| EEE Inc. | 5 Street | Town | 12345 | 513 | $141,654 | 90.1378 | 38.6672 |
| FFF Inc. | A Street | Town | 11111 | 247 | $75,238 | 90.2978 | 38.1272 |
| GGG Inc. | B Street | Town | 12345 | 15 | $91,920 | 90.1018 | 38.6212 |
| HHH Inc. | C Street | Town | 33333 | 796 | $250,280 | 90.0968 | 38.6012 |
| III Inc. | D Street | Town | 11111 | 863 | $120,500 | 90.5978 | 38.5272 |
| JJJ Inc. | E Street | Town | 12345 | 313 | $122,754 | 90.1478 | 38.7672 |
| LLL Inc. | 1 Lane | Town | 12345 | 297 | $135,258 | 90.2978 | 38.1272 |
| NNN Inc. | 2 Lane | Town | 33333 | 112 | $111,980 | 90.1578 | 38.6072 |
| OOO Inc. | 3 Lane | Town | 33333 | 529 | $230,680 | 89.1968 | 37.6212 |
| QQQ Inc. | 4 Lane | Town | 11111 | 890 | $125,500 | 90.4978 | 38.3272 |
| RRR Inc. | 6 Lane | Town | 33333 | 92 | $217,380 | 90.1918 | 38.6292 |

TABLE 2

| Merchant | Block Group | Census Tract |
|---|---|---|
| AAA Inc. | 213600040136 | 21360004014 |
| BBB Inc. | 213600040136 | 21360004012 |
| CCC Inc. | 213600040037 | 21360004014 |
| DDD Inc. | 213600040031 | 21360004012 |
| EEE Inc. | 213600040031 | 21360004021 |
| FFF Inc. | 213600040031 | 21360004021 |
| GGG Inc. | 213600040037 | 21360004012 |
| HHH Inc. | 213600040136 | 21360004014 |
| III Inc. | 213600040031 | 21360004021 |
| JJJ Inc. | 213600040031 | 21360004012 |
| LLL Inc. | 213600040037 | 21360004014 |
| NNN Inc. | 213600040037 | 21360004014 |
| OOO Inc. | 213600040037 | 21360004012 |
| QQQ Inc. | 213600040136 | 21360004021 |
| RRR Inc. | 213600040136 | 21360004021 |

The merchants were then grouped together into three different geographic boundaries based on postal code. The final grouping is shown in Table 3. For each geographic boundary, the grouping of merchants satisfied the previously described benchmark that, for merchant data, each geographic boundary should include a total of at least five merchants, and no one of the merchants in the geographic boundary should comprise twenty-five percent or more of the total transaction amount in the geographic boundary.

TABLE 3

| | | | Postal | | |
|---|---|---|---|---|---|
| Merchant | Street | City | Code | Count | Amount |
| AAA Inc. | 1 Street | Town | 11111 | 247 | $90,238 |
| DDD Inc. | 4 Street | Town | 11111 | 810 | $110,500 |
| FFF Inc. | A Street | Town | 11111 | 247 | $75,238 |
| III Inc. | D Street | Town | 11111 | 863 | $120,500 |
| QQQ Inc. | 4 Lane | Town | 11111 | 890 | $125,500 |
| CCC Inc. | 3 Street | Town | 12345 | 726 | $150,280 |
| EEE Inc. | 5 Street | Town | 12345 | 513 | $141,654 |
| GGG Inc. | B Street | Town | 12345 | 15 | $91,920 |
| JJJ Inc. | E Street | Town | 12345 | 313 | $122,754 |
| LLL Inc. | 1 Lane | Town | 12345 | 297 | $135,258 |
| BBB Inc. | 2 Street | Town | 33333 | 108 | $199,920 |
| HHH Inc. | C Street | Town | 33333 | 796 | $250,280 |
| NNN Inc. | 2 Lane | Town | 33333 | 112 | $111,980 |
| OOO Inc. | 3 Lane | Town | 33333 | 529 | $230,680 |
| RRR Inc. | 6 Lane | Town | 33333 | 92 | $217,380 |

Next, the demand indices for the merchant data (the transaction count indices and the transaction amount indices) were calculated using the following formulas:

$${Index}_{TC} = \frac{{Count}_{Max}}{{Count}_{Avg}} \times Multiplier \qquad ( 1 )$$

where
Index_{TC} is the transaction count index
Count_{Max} is the maximum transaction count
Count_{Avg} is the average transaction count

$${Index}_{Amt} = \frac{{Amount}_{Max}}{{Amount}_{Avg}} \times Multiplier \qquad ( 2 )$$

where
Index_{Amt} is the transaction amount index
Amount_{Max} is the maximum transaction amount
Amount_{Avg} is the average transaction amount

As indicated in Formula (1), in calculating the transaction count index for each of the three different geographic boundaries, the maximum transaction count for the particular geographic boundary, taking into account transaction counts for all merchants, was divided by the average transaction count for the geographic boundary, and then adjusted using a multiplier of 20. And as indicated in Formula (2), in calculating the transaction amount index for each of the three different geographic boundaries, the maximum transaction amount for the particular geographic boundary, taking into account transaction amounts for all merchants, was divided by the average transaction amount for the geographic boundary, and then adjusted using a multiplier of 10. The resulting demand indices for the three geographic boundaries, including both the transaction count indices and the transaction amount indices, are shown in Table 4.

TABLE 4

| Postal Code | Index_{TC} | Index_{Amt} |
|---|---|---|
| 11111 | 26 | 11 |
| 12345 | 28 | 8 |
| 33333 | 55 | 31 |

It should be appreciated that values other than average transaction count and average transaction amount may be used in Formulas (1) and/or (2) (e.g., median transaction count, median transaction amount, mean transaction amount, mean transaction amount, etc.). In addition, it should be appreciated that different multipliers may be used, for example, as needed to improve conversion of the transaction count and/or transaction amount values to a scale of one to one hundred. It should also be appreciated that additional groupings of the merchants may be done, for example, based on the associated block group and/or census track (or even based on state, county, city, direct marketing areas, etc.) to provide additional levels of demand indices. And it should further be appreciated that the Formulas (1) and (2) herein may be used to calculated demand indices for ATM data as well (however, other formulas and/or calculations may also be used).

### Example 2

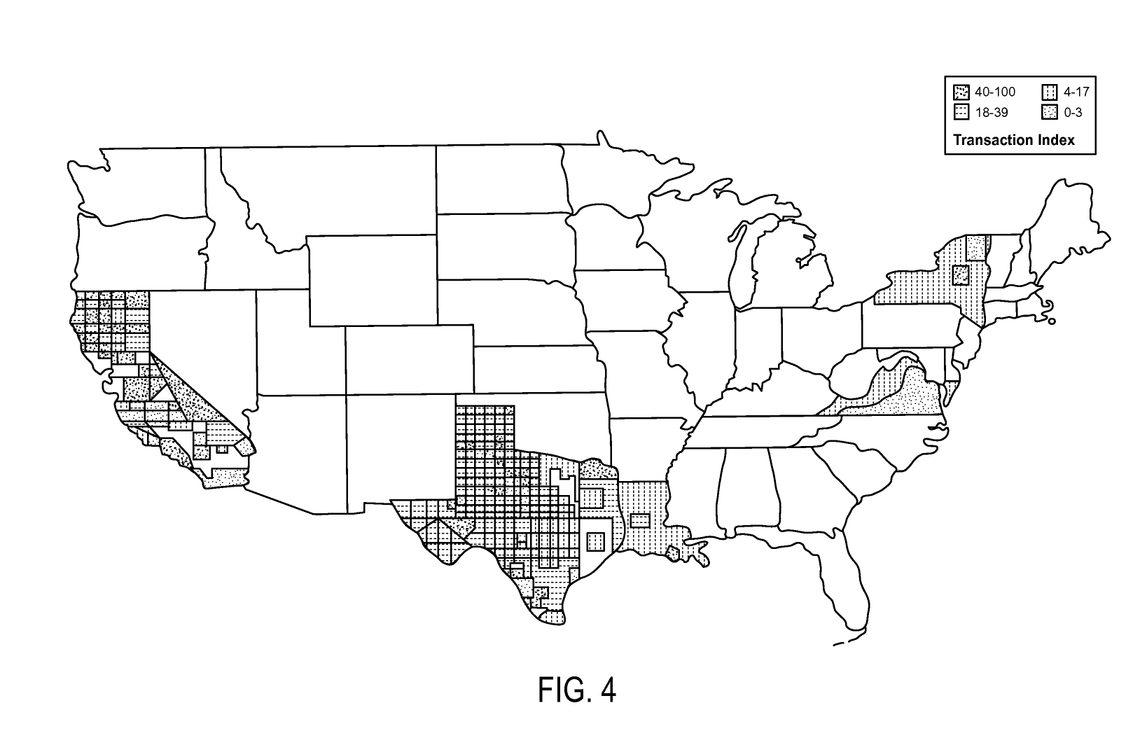

In the following example, demand indices (calculated in accordance with the present disclosure) and related transaction data were incorporated into an interactive map, in different layers, to illustrate demand for various merchants and ATMs in different geographic boundaries (and over different time frames). FIGS. 4-10 illustrate various interfaces that can be displayed by a processor in connection with the map for viewing the different layers and for allowing interaction with the map by a user. Exemplary details and features of the map, and available interactions therewith, will be described in connection with the interfaces.

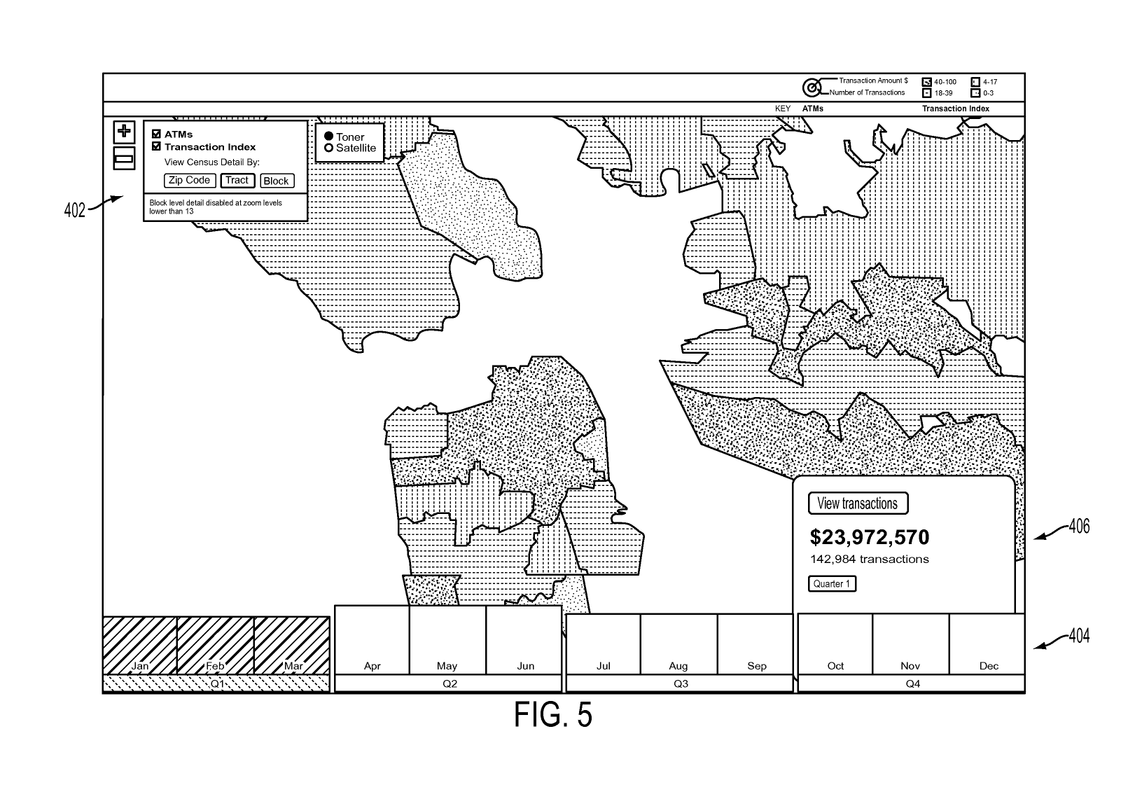

As generally shown in the interfaces of FIGS. 4-6 and 9, the demand indices can be displayed on the map at multiple different geographic levels. For example, the interface of FIG. 4 displays demand indices for various states on a national level. The interfaces of FIGS. 5, 6, and 9, then show the demand indices at progressively more detailed geographic levels (and arranged in different geographic boundaries), for viewing more detailed and specific merchant and ATM information (e.g., upon receiving zoom selections from the user using zoom buttons, etc.).

In the interface of FIG. 5, the demand indices are displayed on the map at a generally regional level. The demand indices for the merchant data are active, as indicated in status box 402, and the demand indices for the ATM data are inactive. The demand indices for the merchant data are color coded to show the different levels of demand within the different geographic boundaries viewable in the interface. Geographic boundaries shown in darker colors represent areas with higher merchant demand, and geographic boundaries shown in lighter colors represent areas with lower merchant demand. The geographic boundaries shown in white include areas that lack sufficient merchant data to calculate demand indices, or include areas that failed to satisfy the predefined benchmark for merchant data (and thus were omitted from the map).

Also in the interface of FIG. 5, the demand indices for the merchant data are shown for geographic boundaries defined by zip code (as indicated in the status box 402). However, options are available in the interface, through the status box 402, to instead display the demand indices for geographic boundaries defined by census tract or by block group. In addition, a time frame bar 404, located along the bottom of the interface, indicates the time frame for which the demand indices are displayed. In this interface, the time frame is a first quarter (Q1) of the year. However, options are again available in the interface to instead display the demand indices for different time frames of the year (e.g., a second quarter (Q2), a third quarter (Q3), a fourth quarter (Q4), a specific month, etc.). Further, a detail window 406 is provided to indicate cumulative transaction details (e.g., cumulative merchant details in FIG. 5 including total number of transactions and total transaction amounts) during the time frame for all geographic boundaries viewable in the interface. It should be appreciated that the cumulative transaction details in the detail window 406 are fluid. And, as the geographic boundaries viewable in the interface change, so do the cumulative transaction details in the detail window 406.

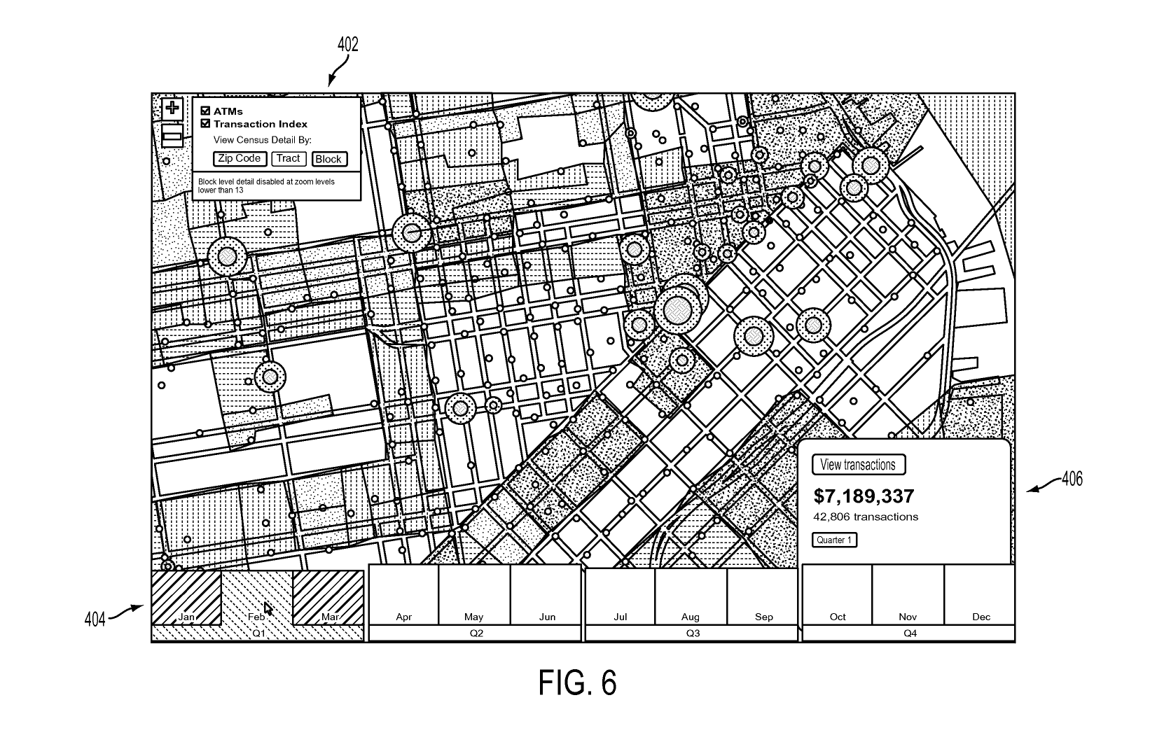

In the interface of FIG. 6, demand indices for the merchant data are now shown in a more detailed level than in FIG. 5, and for geographic boundaries now defined by census tract (as indicated in the status box 402). In addition, ATM data is now also active (as indicated in the status box 402), with corresponding demand indices therefore also included on the map. The demand indices for the ATM data are identified by circles, with each circle representing either a single ATM or multiple ATMs located in close vicinity. Outer portions of the circles represent a number of transactions at the ATMs, and inner portions of the circles represent transaction amounts at the ATMs. In addition, the circles are sized to show the different levels of demand for the ATMs. Larger circles represent ATMs with higher demand while smaller circles represent ATMs with lower demand. Additional, smaller circles are also included on the map and represent ATMs for which specific transaction information is not available. Further in this interface, the detail window 406 is updated to now indicate cumulative transaction details (cumulative merchant details and cumulative ATM details) for all of the geographic boundaries viewable in the interface, for the first quarter time frame.

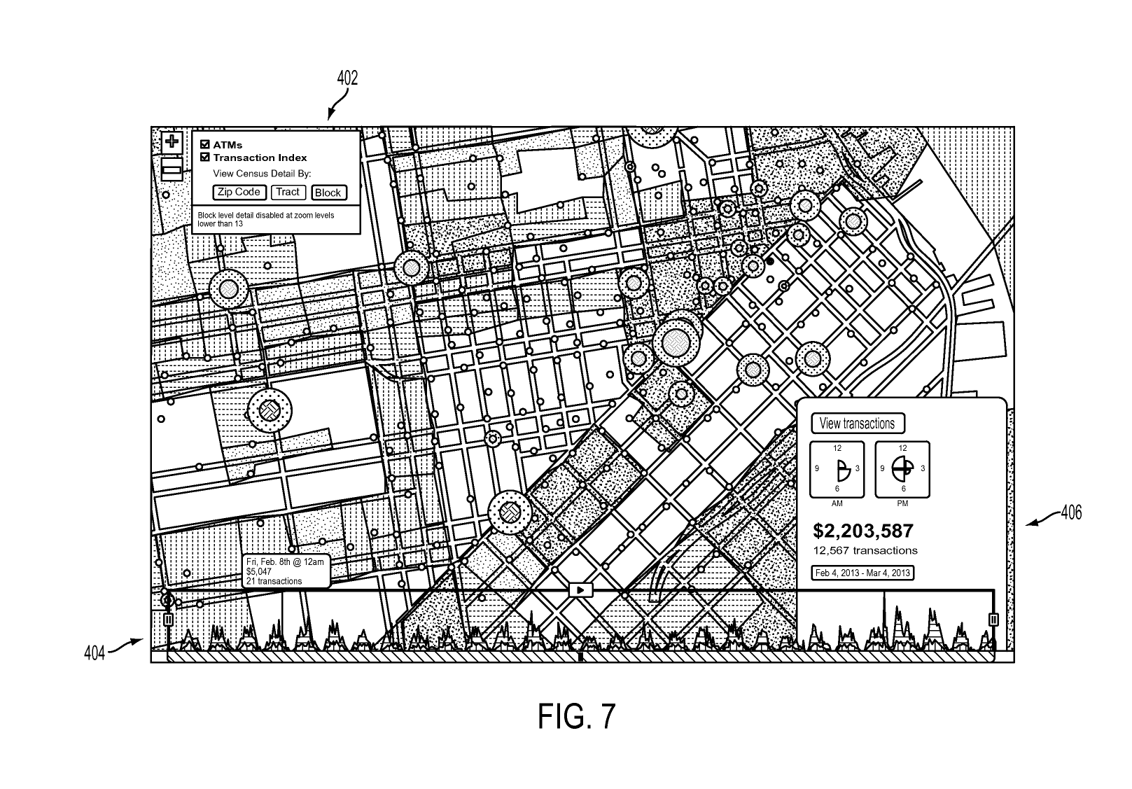

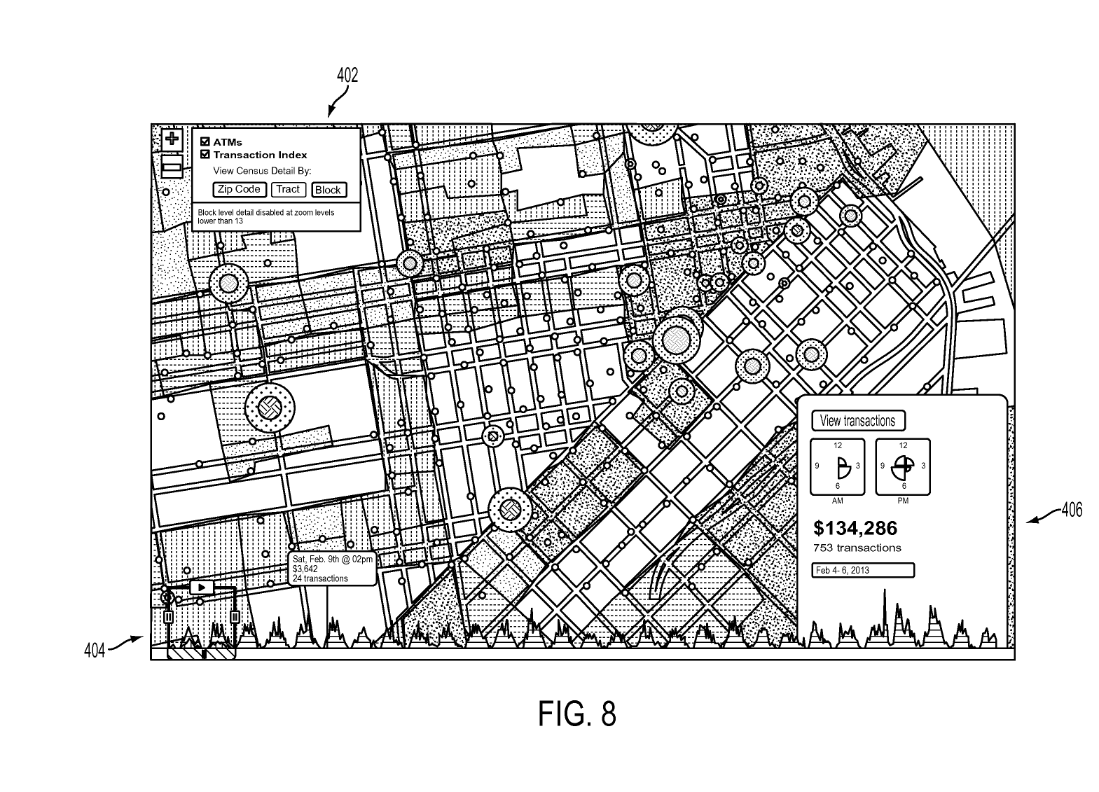

The interfaces of FIGS. 7 and 8 are similar to the interface of FIG. 6, but further show transaction details for specific time periods in the first quarter. For example, FIG. 7 shows transaction details for the month of February, and FIG. 8 shows transaction details for the dates of February 4 thru February 6. In both interfaces, upon request from the user, the processor can put the merchant and ATM information in motion (e.g., play the information, etc.) over the selected time period to view the changes in real time. As can be appreciated, this feature may be used to compare trends in the merchant and ATM information over the selected time period, or to monitor or following transaction details. Also in these interfaces, the detail windows 406 include timing charts indicating at what times during the day the merchant and ATM transactions occurred. Further, the time frame bar 404 now includes a chart illustrating a comparison of transaction details for the selected data included in the map and viewable in the interface to transaction details for all data for the viewable geographic boundaries.

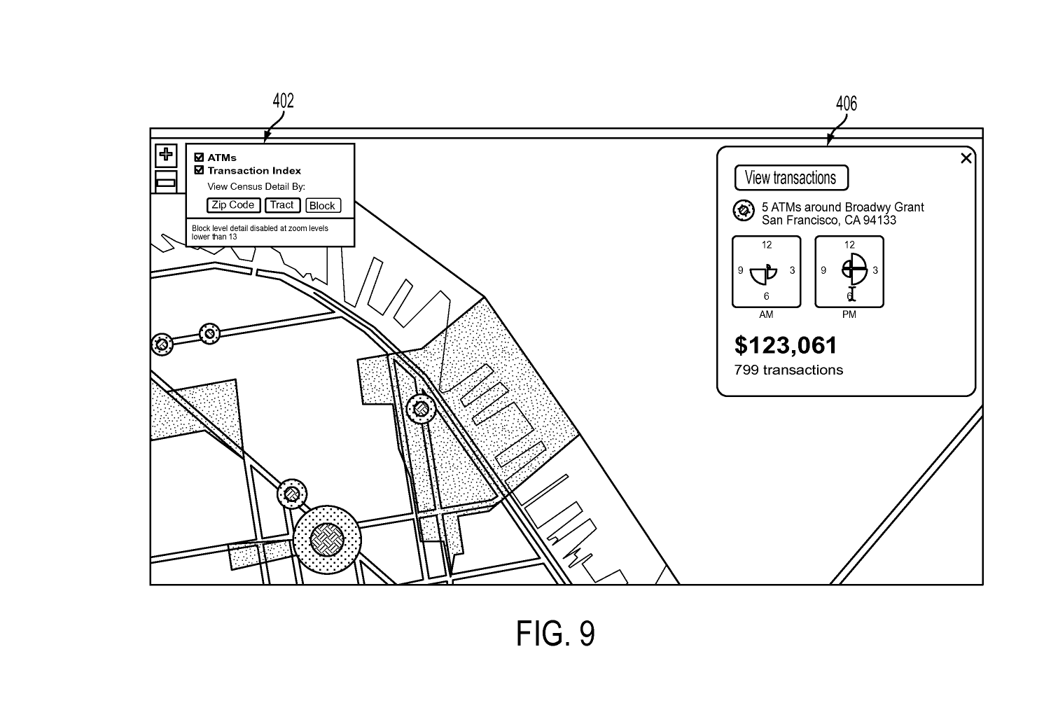

In the interface of FIG. 9, demand indices for the merchant data and ATM data for the first quarter time frame are shown in a more detailed level than in FIGS. 6-8, and for geographic boundaries now defined by block group (as indicated in the status box 402). In this interface, upon selection of a particular ATM from the user (e.g., a particular circle representing an ATM, etc.), the processor displays cumulative transaction details for the ATM over the first quarter time frame, including the total number of transactions that occurred at the ATM, the total amount of all of the transactions, and the timing of the transactions during the day.

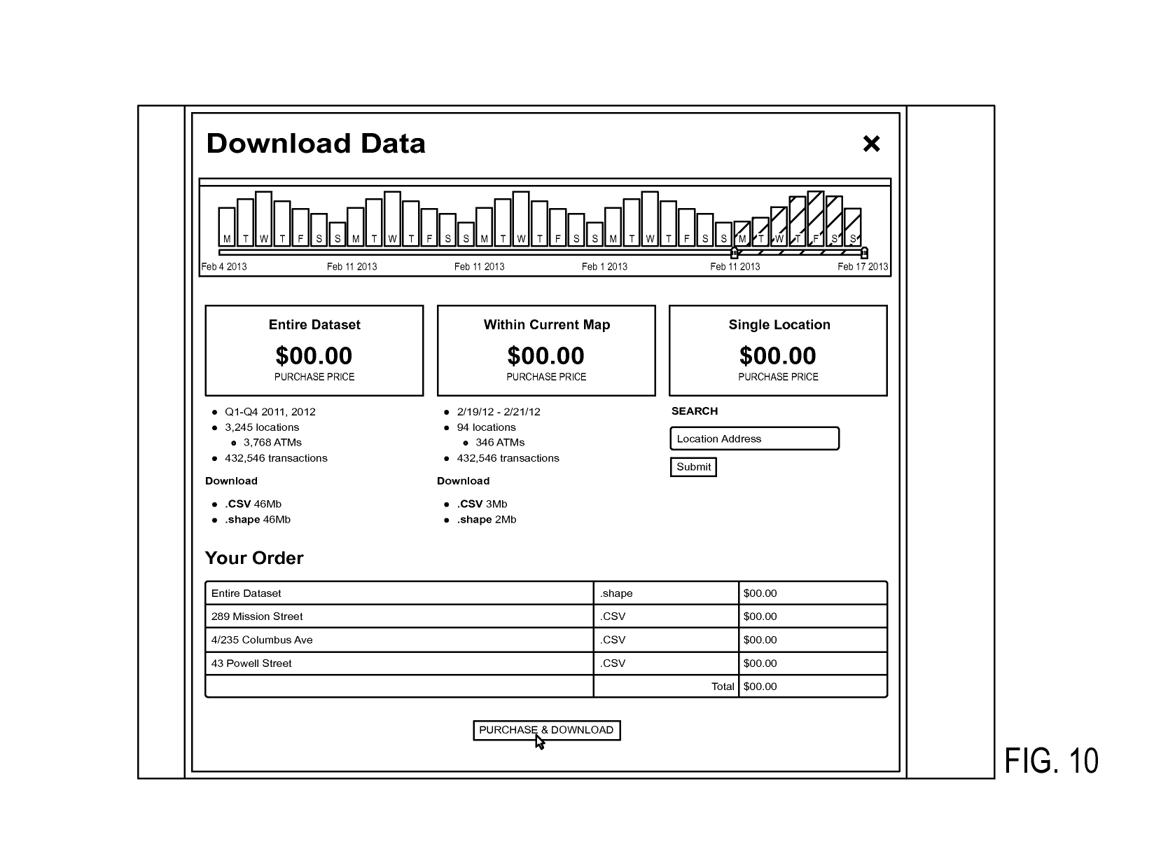

And, the interface of FIG. 10 allows a user to download particular data from the map as desired. For example, each of the detail windows 406 in the interfaces of FIGS. 5-9 allows for selections, by the user, to view particular transaction details associated with the information in the detail windows. Upon receiving such a selection from the user, the processor provides the interface of FIG. 10 to allow the user to access the desired details.

It should be appreciated that, in some aspects, maps showing demand indices may allow users to view actual data for only their transactions (e.g., for merchants and/or ATMs they own or service, etc.). Here, data relating to transactions of other users may be included on the map, but will only be viewable in scaled values.

Again, and as previously describe, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving, at a computing device, transaction data for transactions conducted over a selected time period, (b) associating, at the computing device, location data with each of the transactions, the location data corresponding to a location at which each of the transactions occurred, (c) grouping the transactions into geographic boundaries based on the location data, (d) for each of the geographic boundaries, comparing the transaction data for the grouped transactions to a predefined benchmark, and (e) for each of the geographic boundaries satisfying the benchmark, generating, at the computing device, at least one demand index indicative of financial demand in the geographic boundary.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” or “included with” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method for identifying financial demand within geographic boundaries over a selected time period, the method comprising:
receiving, at a computing device, transaction data for transactions conducted over a selected time period;
associating, at the computing device, location data with each of the transactions, the location data corresponding to a location at which each of the transactions occurred;
grouping the transactions into geographic boundaries based on the location data;
for each of the geographic boundaries, comparing the transaction data for the grouped transactions to a predefined benchmark; and
for each of the geographic boundaries satisfying the benchmark, generating, at the computing device, at least one demand index indicative of financial demand in the geographic boundary.

2. The method of claim 1, further comprising, for each of the geographic boundaries not satisfying the benchmark, regrouping the transactions with transactions in another geographic boundary.

3. The method of claim 1, wherein the transaction data includes merchant transaction data from multiple merchants, and wherein grouping the transactions into geographic boundaries includes grouping the merchants associated with the transactions into the geographic boundaries.

4. The method of claim 3, wherein comparing the transaction data for the grouped transactions to a predefined benchmark includes, for each of the geographic boundaries, determining if the geographic boundary includes a predefined total number of merchants, and confirming that none of the merchants in the geographic boundary comprises more than a predefined percentage of the total transaction amount in the geographic boundary.

5. The method of claim 1, wherein the transaction data includes ATM transaction data, and wherein grouping the transactions into geographic boundaries includes grouping the ATMs associated with the transactions into the geographic boundaries.

6. The method of claim 5, wherein comparing the transaction data for the grouped transactions to a predefined benchmark includes, for each of the geographic boundaries, determining if the geographic boundary includes a predefined total number of ATMs, and confirming that none of the ATMs in the geographic boundary comprise more than a predefined percentage of the total transaction amount in the geographic boundary.

7. The method of claim 5, further comprising confirming the received ATM data using predetermined ATM data.

8. The method of claim 1, wherein the demand index is represented on a scale of one to one hundred.

9. The method of claim 8, further comprising displaying a map illustrating the at least one demand index.

10. The method of claim 1, wherein the geographic boundaries are defined by one or more of a zip code, a block group, and a census tract.

11. A system for identifying merchant and ATM demand within geographic boundaries over a selected time period, the system comprising:
a memory configured to store transaction data for transactions conducted at merchants and ATMs over a selected time period; and
a processor configured to:
associate location data with each of the merchants and ATMs;
group the merchants into geographic boundaries based on the location data;
group the ATMs into geographic boundaries based on the location data;
generate merchant demand indices for the geographic boundaries in which the merchants are grouped; and
generate ATM demand indices for the geographic boundaries in which the ATMs are grouped.

12. The system of claim 11, wherein for each of the geographic boundaries in which the merchants are grouped, the processor is configured to generate the merchant demand indices only if a geographic boundary includes a predefined total number of merchants and no one merchant in the geographic boundary comprises more than a predefined percentage of the total transaction amount in the geographic boundary.

13. The system of claim 12, wherein for a geographic boundary that does not include a predefined total number of merchants or one merchant in the geographic boundary comprises more than a predefined percentage of the total transaction amount in the geographic boundary, the processor is further configured to regroup the merchant(s) from said geographic boundary with merchants from another geographic boundary.

14. The system of claim 11, wherein for each of the geographic boundaries in which the ATMs are grouped, the processor is configured to generate the ATM demand indices only if a geographic boundary includes a predefined total number of ATMs and no one ATM in the geographic boundary comprises more than a predefined percentage of the total transaction amount in the geographic boundary.

15. The system of claim 14, wherein for a geographic boundary that does not include a predefined total number of ATMs or one ATM in the geographic boundary comprises more than a predefined percentage of the total transaction amount in the geographic boundary, the processor is further configured to regroup the ATM(s) from said geographic boundary with ATMs from another geographic boundary.

16. The system of claim 14, wherein the processor is further configured to confirm the received ATM data using predetermined ATM data.

17. The system of claim 11, wherein the processor is further configured to generate a map illustrating the at least one demand index.

18. The system of claim 17, wherein the processor is further configured to:
display the ATMs, grouped into the geographic boundaries, on the map; and
display at least one transaction detail on the map associated with at least one of the ATMs.

19. The system of claim 17, wherein the processor is further configured to:
display the merchants, grouped into the geographic boundaries, on the map; and
display at least one transaction detail on the map associated with at least one of the merchants.

20. The system of claim 17, wherein the geographic boundaries are defined by one or more of a zip code, a block group, and a census tract.
